(19) United States
(12) Patent Application Publication
(10) Pub. No.: US 2026/0068803 A1
(43) Pub. Date: Mar. 12, 2026

(54) Agricultural Harvester and Method for Operating Same

(71) Applicant: CLAAS Saulgau GmbH, 88348 Bad Saulgau (DE)

(72) Inventors: Stefan Birkhofer, Stockach (DE); Stefan Sauter, Zwiefalten (DE)

(21) Appl. No.: 19/313,740

(22) Filed: Aug. 28, 2025

(30) Foreign Application Priority Data
Sep. 10, 2024 (DE) 102024126013.0

(51) Int. Cl. A01B 73/06; A01D 89/00

(52) U.S. Cl. CPC A01B 73/067; A01D 89/003

(57) ABSTRACT

Agricultural harvester (10), having a frame (11) on which a chassis (15) engages, having booms (17), wherein on both sides of the frame (11) in each case at least one boom (17) engages on the frame in such a way that, in order to transfer the harvester (10) between a working position and a transport position, the respective boom (17) can be displaced relative to the frame (11), having working units (18), wherein in each case at least one working unit (18) engages on each of the booms (17) and can be displaced together with the respective boom (17), having pivoting cylinders (23) and lifting cylinders (24), wherein on each side of the frame (11) in each case a pivoting cylinder (23) and in each case a lifting cylinder (24) are arranged which displace the at least one boom (17) arranged on the respective side of the frame (11), together with the at least one working unit (18), over a respective transfer movement between the working position and the transport position, having a control unit and/or at least one device for hydraulic flow distribution which are designed to simultaneously hydraulically control the pivoting cylinder (23) and lifting cylinder (24) arranged on the respective side of the frame (11) in order to transfer the harvester (10) between the working position and the transport position at least over part of the transfer movement of the at least one boom (17) arranged on the respective side of the frame (11) and to simultaneously use them for the respective transfer movement.

The invention relates to an agricultural harvester. The invention also relates to a method for operating an agricultural harvester.

Agricultural harvesters that can be coupled to a towing vehicle in order to be moved by being pulled with the aid of the towing vehicle, thus pulled by the towing vehicle, are known in practice. Such agricultural harvesters, moved by being pulled by a towing vehicle, include in particular forage harvesters, for example windrowers or tedders.

EP 2 979 529 B1 discloses an agricultural harvester designed as a merger. Mergers are also referred to as pickup belt rakes. A merger has a frame or framework on which a chassis and a drawbar engage. The agricultural harvester can be coupled to a towing vehicle via the drawbar and a coupling bracket interacting with the drawbar in order to be pulled along by the towing vehicle. The harvester is supported on the ground via the chassis. Booms engage on the frame or framework on both sides, with the booms receiving working units. In the case of a merger, the working units have pickups to pick up crop from the ground and belt conveyor segments to convey the crop.

If the harvester known from EP 2 979 529 B1 is to be transferred between a working position and a transport position, the working units are first folded upward about a horizontal axis from their working position, and then the upwardly folded working units can be folded forward about a vertical axis, namely together with the booms receiving the working units. According to EP 2 979 529 B1, it is therefore necessary to first fold the working members upward about a horizontal axis extending in the transverse direction and then forward about a vertical axis together with the booms.

DE 10 2019 118 738 A1 discloses a further agricultural harvester designed as a merger. If this harvester is to be transferred from the working position into the transport position, the working units together with the booms receiving the working units are first displaced into an intermediate position relative to the frame or framework about an axis extending in the vertical direction in order to then be displaced from this intermediate position relative to the frame or framework into the transport position about an axis extending in the horizontal longitudinal direction. Here, too, the working units are accordingly displaced sequentially about different axes.

DE 10 2020 106 804 A1 discloses a harvester designed as a merger, in which the frame or the framework has two sections which are displaceable relative to each other to change the distance of the working units from the ground.

There is a need for an agricultural harvester that can be advantageously transferred between the transport position and the working position. There is also a need for a method for operating such an agricultural harvester in order to transfer it between the transport position and the working position.

The object of the invention is to provide a corresponding agricultural harvester and a method for operating same.

This object is achieved by an agricultural harvester according to claim 1 and by a method according to claim 12.

The agricultural harvester according to the invention has a frame or a framework on which a chassis engages.

The agricultural harvester according to the invention also has booms, wherein on both sides of the frame or framework in each case at least one boom engages on the frame or framework in such a way that, in order to transfer the harvester between a working position and a transport position, the respective boom can be displaced relative to the frame or framework.

The agricultural harvester according to the invention also has working units, wherein in each case at least one working unit engages on each of the booms and can be displaced together with the respective boom.

The agricultural harvester according to the invention also has pivoting cylinders and lifting cylinders, wherein on each side of the frame or framework in each case a pivoting cylinder and in each case a lifting cylinder are arranged which displace the at least one boom arranged on the respective side of the frame or framework, together with the at least one working unit, over a respective transfer movement between the working position and the transport position.

The agricultural harvester according to the invention also has a control unit which is designed to simultaneously hydraulically control the pivoting cylinder and lifting cylinder arranged on the respective side of the frame or framework in order to transfer the harvester between the working position and the transport position at least over part of the transfer movement of the at least one boom arranged on the respective side of the frame or framework and to simultaneously use them for the respective transfer movement.

In the harvester according to the invention, the booms together with the working units received on the booms can be simultaneously displaced about different axes in order to transfer the harvester between the working position and the transport position. For this purpose, pivoting cylinders and lifting cylinders are simultaneously hydraulically controlled and used for the respective transfer movement between the working position and the transport position of the harvester. During this transfer movement, the booms with the working units received on the booms accordingly carry out a three-dimensional movement with a simultaneous pivoting or tilting movement about a plurality of axes.

The booms arranged on both sides of the frame or framework extend in the transverse direction of the harvester in the working position thereof and in the longitudinal direction of the harvester in the transport position thereof, wherein the control unit is preferably designed to simultaneously hydraulically control the pivoting cylinders and lifting cylinders arranged on both sides of the frame or framework in order to transfer the harvester between the working position and the transport position at least over that part of the transfer movement in which the booms are transferred between the extension in the transverse direction of the harvester and the extension in the longitudinal direction and to simultaneously use them for the respective transfer movement. This is particularly preferred for transferring the harvester between the working position and the transport position.

Preferably, the respective pivoting cylinder articulatedly engages on one side on the frame or framework and on the other side on the respective boom, wherein, in the working position of the harvester, a folding axis extends between the respective pivoting cylinder and the respective boom in approximately the vertical direction. The respective lifting cylinder preferably articulatedly engages on one side on the frame or framework and on the other side on the respective boom, wherein, in the working position of the harvester, a folding axis extends between the respective lifting cylinder and the respective boom in the horizontal direction. This is also particularly preferred for transferring the harvester between the working position and the transport position.

Preferably, on both sides of the frame or framework in each case at least one receptacle engages on the frame or framework and is designed for form-fittingly arranging a boom arranged on the respective side of the frame or framework in the transport position of the harvester, wherein the control unit is designed, when the booms arranged on both sides of the frame or framework extend in the longitudinal direction of the harvester, to hydraulically control exclusively the respective pivoting cylinder and use it for the respective transfer movement in order, during the transfer of the harvester from the working position into the transport position, to move the respective boom into the respective receptacle and, during the transfer of the harvester from the transport position into the working position, to move the respective boom out of the respective receptacles. As a result, the booms and thus also the working units received on the booms assume a defined position in the transport position and are held in a form-fitting manner in the transport position.

Preferably, the frame or the framework has a first section on which the chassis engages, and a second section on which the drawbar engages, wherein these two sections can be displaced relative to each other by means of an articulated cylinder about an axis extending in the transverse direction in order to change the distance of the working units from the ground. In particular, the control unit is designed to hydraulically control the articulated cylinder at least over part of the transfer movement of the booms simultaneously with the pivoting cylinders and lifting cylinders and to simultaneously use them for the respective transfer movement. This can further improve the transfer of the agricultural harvester between the working position and the transport position.

Preferably, the agricultural harvester is a forage harvester, in particular a merger or pickup belt rake, wherein a pickup and a belt conveyor segment engages, as working unit, on each of the booms. The invention is preferably used in a merger.

Preferred developments of the invention can be gathered from the dependent claims and from the following description. Exemplary embodiments of the invention are explained in more detail on the basis of the drawing, without being limited thereto. In the drawing:

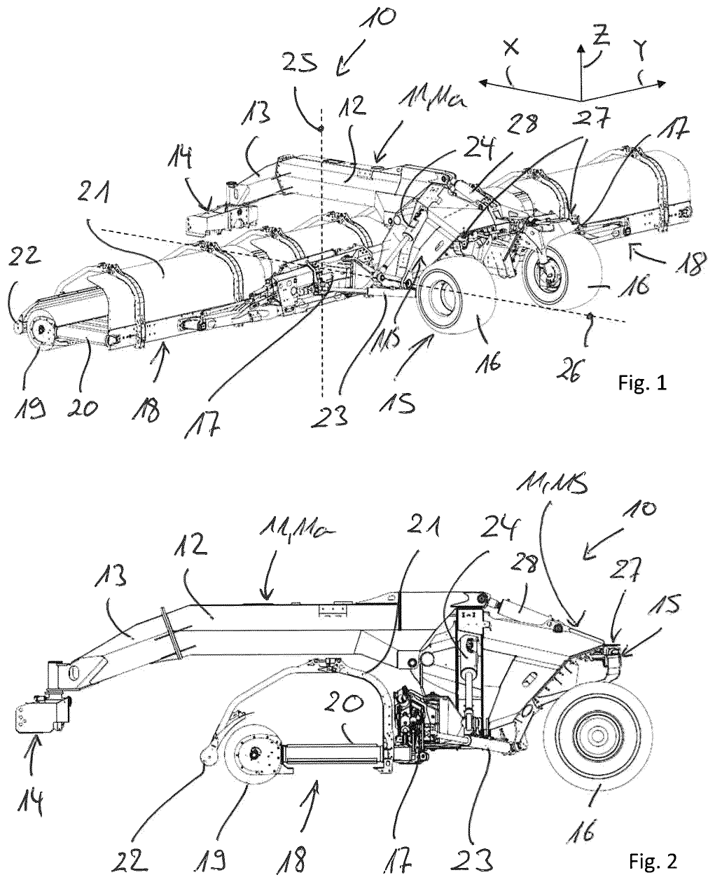

FIG. 1 shows a perspective view from behind of an agricultural harvester according to the invention in the working position thereof;

FIG. 2 shows the agricultural harvester of FIG. 1 in a side view;

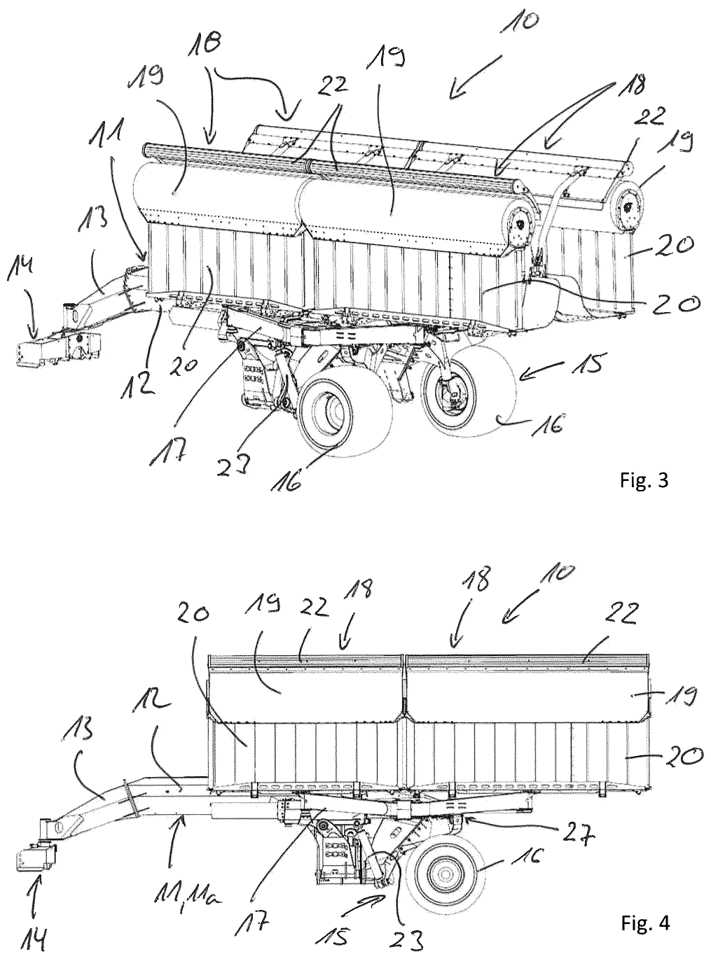

FIG. 3 shows a perspective view from behind of the agricultural harvester according to the invention in the transport position thereof;

FIG. 4 shows the agricultural harvester of FIG. 3 in a side view;

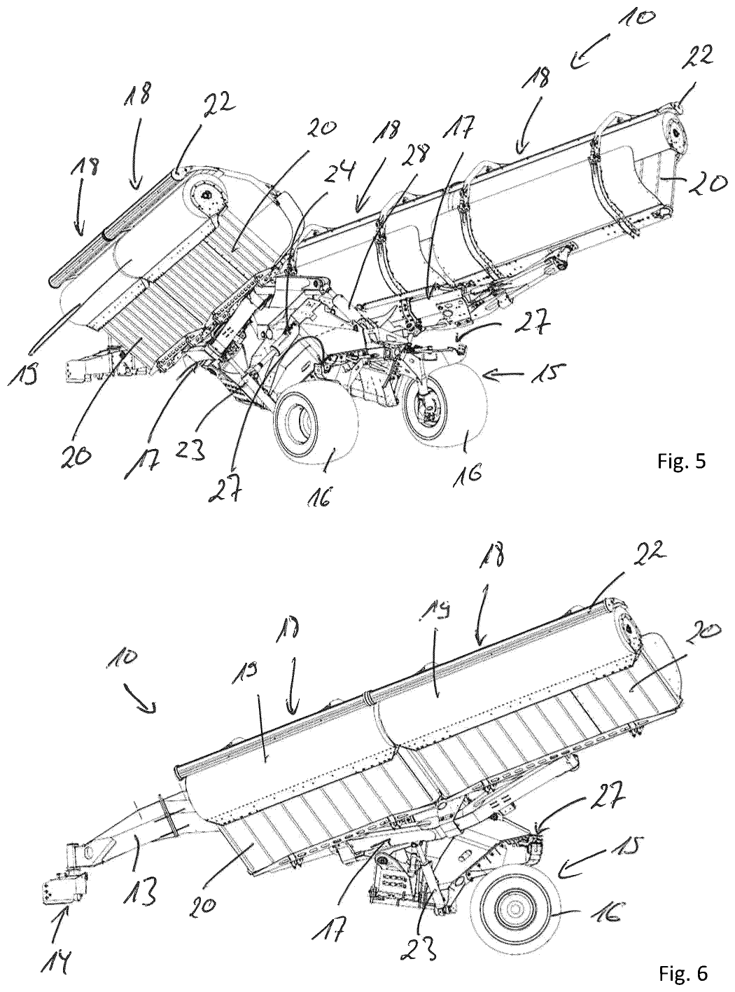

FIG. 5 shows a perspective view from behind of the agricultural harvester according to the invention during the transfer thereof between the working position and the transport position thereof;

FIG. 6 shows the agricultural harvester of FIG. 5 in a side view;

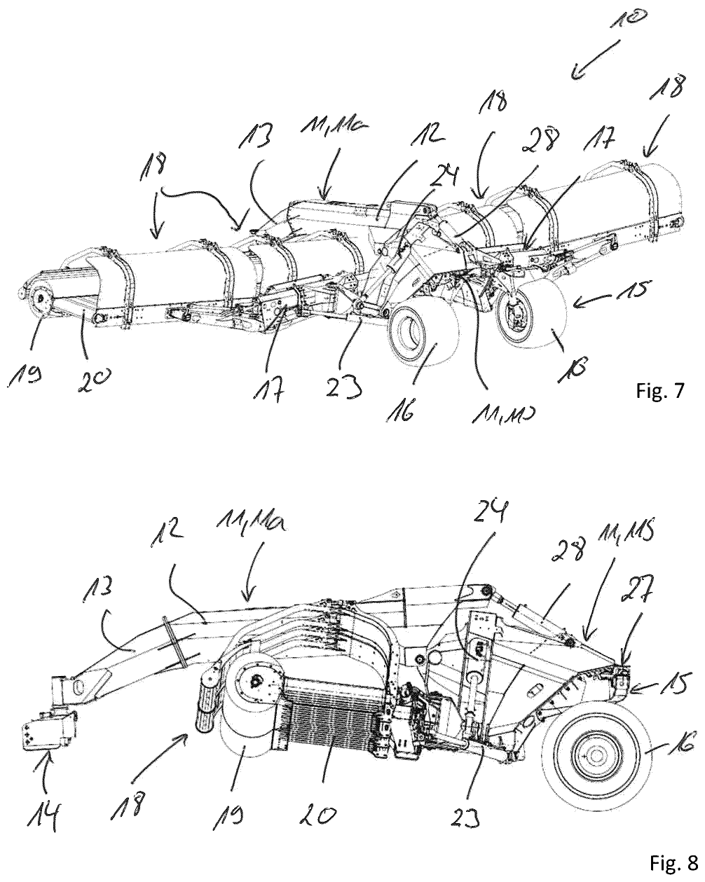

FIG. 7 shows a perspective view from behind of the agricultural harvester according to the invention in a headland position thereof;

FIG. 8 shows the agricultural harvester of FIG. 7 in a side view.

The invention relates to an agricultural harvester 10.

The agricultural harvester 10 is, in particular, a forage harvester that can be coupled to a towing vehicle in order to be pulled by the towing vehicle.

The forage harvester shown in the figures is a merger, which is also referred to as a pickup belt rake.

The agricultural harvester 10 has a framework or a frame 11, wherein the framework or the frame 11 has a longitudinal member 12 which extends in the longitudinal direction X of the agricultural harvester.

According to FIG. 1, a drawbar 13 engages on the framework or frame 11, namely on the longitudinal member 12, and serves to couple the harvester 10 via a coupling bracket 14 to a towing vehicle. When the harvester 10 is coupled to a towing vehicle, a relative movement between the drawbar 13 and the coupling bracket 14 about an axis extending in the vertical direction Z is possible. Furthermore, a relative movement between the coupling bracket 14 and the towing vehicle about an axis extending in the horizontal transverse direction Y is possible.

A chassis 15 with wheels 16 engages on the frame or framework 11. When the agricultural harvester 10 is being pulled along by means of a towing vehicle, the wheels 16 of the chassis 15 are supported on the ground.

The agricultural harvester 10 also has booms 17. On both sides of the frame or framework 11, namely on both sides of the longitudinal member 12, in each case at least one boom 17 engages on the frame or framework 11, namely in such a way that, in order to transfer the harvester 10 between a working position (FIGS. 1 and 2) and a transport position (FIGS. 3 and 4), the respective boom 17 can be displaced relative to the frame or framework 11.

The agricultural harvester 10 also has working units 18. In each case at least one working unit 18 engages on each boom 17 and can be displaced together with the respective boom 17, namely during the transfer of the harvester 10 between the working position and the transport position.

In the exemplary embodiment shown, in which the agricultural harvester 10 is designed as a merger, each working unit 18 has a pickup 19 and a belt conveyor segment 20.

Furthermore, coverings 21 for the working units 18 are shown in the region of the working units 18 on a side situated to the rear in the pulling direction or longitudinal direction X, wherein roller hold-down devices 22 for the crop engage on the coverings 21.

In the exemplary embodiment shown, in each case two working units 18 are arranged on both sides of the frame or framework 11, namely on both sides of the longitudinal member 12, on respective booms 17.

The agricultural harvester 10 also has pivoting cylinders 23 and lifting cylinders 24. On each side of the frame or framework 11, namely on each side of the longitudinal member 12, in each case a pivoting cylinder 23 and in each case a lifting cylinder 24 are arranged which displace the at least one boom 17 arranged on the respective side of the frame or framework 11, together with the at least one working unit 18 engaging on the respective boom 17, over a respective transfer movement between the working position and the transport position of the harvester 10.

The respective pivoting cylinder 23 in each case articulatedly engages on one side on the frame or framework 11 and on the other side on the respective boom 17, wherein, in the working position of the harvester 10 (see FIG. 1), a folding axis 25 extends between the respective pivoting cylinder 23 and the respective boom 17 in the vertical direction Z.

The respective lifting cylinder 24 also in each case articulatedly engages on one side on the frame or framework 11 and on the other side on the respective boom 17, wherein, in the working position of the harvester 10 (see FIG. 1), a folding axis 26 extends between the respective lifting cylinder 24 and the respective boom 17 in the horizontal longitudinal direction X of the harvester 10.

The agricultural harvester 10 also has a control unit (not shown) which is designed to simultaneously hydraulically control the pivoting cylinder 23 and the lifting cylinder 24 arranged on the respective side of the frame or framework 11 of the agricultural harvester 10 in order to transfer the harvester 10 between the working position and the transport position at least over part of the transfer movement of the at least one boom 17 arranged on the respective side of the frame or framework 11 and to simultaneously use them for the respective transfer movement. Thus, at least over part of the transfer movement of the agricultural harvester 10 between the working position and the transport position, the booms 17 are simultaneously displaced about the folding axis 25 and about the folding axis 26.

The control unit is designed here to simultaneously hydraulically control the pivoting cylinders 23 and lifting cylinders 24 arranged on both sides of the frame or framework 11 in order to transfer the harvester 10 between the working position and the transport position at least over the respective part of the transfer movement of the booms 17 arranged on both sides of the frame or framework 11 and to simultaneously use them for the respective transfer movement, so that accordingly the booms 17 arranged on both sides of the frame or framework 11, together with the working units 18 engaging thereon, can be simultaneously transferred between the working position and the transport position.

As can be gathered from FIG. 1, the booms 17 arranged on both sides of the frame or framework 11 extend, together with the working units 18 engaging thereon, in the transverse direction Y of the harvester 10 in the working position of the harvester. In the transport position of the harvester 10, the booms 17 arranged on both sides of the frame or framework extend, with the working units 18 arranged thereon, in the longitudinal direction X of the harvester 10. This is shown in FIGS. 3 and 4.

The control unit is designed to simultaneously hydraulically control the pivoting cylinders 23 and lifting cylinders 24 arranged on both sides of the frame or framework 11 in order to transfer the harvester between the working position and the transport position over at least that part of the transfer movement and to simultaneously use them for the transfer movement, in which the booms 17 are transferred between the extension thereof, shown in FIG. 1, in the transverse direction Y and the extension thereof, shown in FIG. 3, in the longitudinal direction X.

On both sides of the frame or framework 11, in each case at least one receptacle 27 is formed on the frame or framework 11 and is designed for form-fittingly arranging or receiving a boom 17 arranged on the respective side of the frame or framework 11 in the transport position of the harvester 10.

The control unit is designed, when the booms 17 arranged on both sides of the frame or framework 11 extend, together with the working units 18 engaging thereon, in the longitudinal direction X of the harvester 10, to hydraulically control exclusively the respective pivoting cylinder 23 and to use it for the respective transfer movement of the respective boom 17 in order, during the transfer of the harvester 10 starting from the working position into the transport position, to move the respective boom 17 into the respective receptacle 27 and, during the transfer of the harvester 10 starting from the transport position in the direction of the working position, to move the respective boom 17 out of the respective receptacle 27.

As already stated above, for the transfer movement of the booms 17 with the working units 18 engaging on the booms 17 between the orientation thereof in the transverse direction Y and the orientation thereof in the longitudinal direction X, the pivoting cylinders 23 and the lifting cylinders 24 are simultaneously hydraulically controlled and simultaneously used for the transfer movement, so that accordingly a folding movement simultaneously occurs about the folding axes 25, 26. This provides a three-dimensional transfer movement for the booms 17 and working units 18 of the harvester 10 between the working position and the transport position, wherein the pivoting cylinders 23 and lifting cylinders 24 are either hydraulically controlled via a fixed ratio, for example with linear dependence, or are electro-hydraulically controlled with a variable ratio, where appropriate coupled with monitoring of the respective folding angles about the folding axes 25, 26 using sensors.

In the illustrated exemplary embodiment of the agricultural harvester, the frame or the framework 11 has a first section 11b, on which the chassis 15 engages, and a second section 11a, on which the drawbar 13 engages, wherein these two sections 11a, 11b are displaceable relative to one another about an axis extending in a transverse direction Y of the harvester 10 by means of an articulated cylinder 28, which in each case articulatedly engages on both sections 11a, 11b with opposite ends, so as to change the distance of the working units 18 from the ground.

The control unit of the harvester 10 can be designed to hydraulically control the articulated cylinder 28 at least over part of the transfer movement of the respective boom 17 simultaneously with the respective pivoting cylinder 23 and the respective lifting cylinder 24 and to simultaneously use them for the respective transfer movement.

The articulated cylinder 28 can be advantageously used to place the booms 17 gently on the frame or framework 11 and, by pivoting back the articulation—i.e. retracting the articulated cylinder 28—, locking of the booms 17 on the frame or framework 11 can be activated, as a result of which safe road transport of the harvester 10 is possible.

It may also be provided that, when the harvester 10 is transferred starting from the working position in the direction of the transport position, the distance of the working units 18 in the working position from the ground is first increased via the articulated cylinder 28 in order only subsequently, as a result of the simultaneous hydraulic control of the pivoting cylinders 23 and lifting cylinders 24, to carry out the transfer movement for the booms 17 and the working units 18 fastened to the booms 17 in the direction of the transport position. This is also possible for the reverse transfer of the harvester 10, starting from the transport position into the working position. It is thus possible to prevent the working units 18 from colliding with the ground during the transfer movement of the booms 17 and working units 18 caused by the simultaneous hydraulic control of the pivoting cylinders 23 and lifting cylinders 24.

The invention permits a particularly advantageous transfer of an agricultural harvester 10 between the working position and the transport position thereof, even with large working widths of the harvester 10 of more than 10 meters. As a result of the simultaneous displacement of the booms 17 with the working units 18 engaging on the booms 17 about the folding axes 25, 26, the time required to transfer the harvester between the working position and the transport position can be shortened, and furthermore an optimal position of the center of gravity is always ensured during the displacement movement for improved stability of the harvester 10.

As can best be seen in FIGS. 1 and 2, the pivoting cylinders 23 extend substantially horizontally in the working position, to be precise in a slightly rising manner as seen in the pulling direction X of the harvester 10.

While FIGS. 1 and 2 show the harvester 10 in the working position, FIGS. 3 and 4 show the harvester 10 in the transport position and FIGS. 7 and 8 show the harvester 10 in the headland position, FIGS. 5 and 6 show the harvester 10 during the transfer thereof between the working position of FIGS. 1 and 2 and the transport position of FIGS. 3 and 4 while the pivoting cylinders 23 and lifting cylinders 24 are simultaneously used for transferring the booms 17 and the working units 18 engaging on the booms 17 between the working position and the transport position.

The invention further relates to a method for operating the agricultural harvester 10 according to the invention. In the method according to the invention, during the transfer of the harvester 10 between the working position and the transport position, the pivoting cylinders 23 and lifting cylinders 24 arranged on both sides of the frame or framework 11 are simultaneously hydraulically controlled at least over part of the transfer movement of the booms 17 engaging on the frame or framework 11 and simultaneously used for the respective transfer movement. Accordingly, a simultaneous folding movement simultaneously occurs about the respective folding axes 25, 26 of the pivoting cylinders 23 and the lifting cylinders 24 at least over part of the transfer movement.

When transferring the harvester 10 starting from the working position into the transport position, the pivoting cylinders 23 and lifting cylinders 24 arranged on the two sides of the frame or framework 11 are first simultaneously hydraulically controlled and used for the respective transfer movement until the booms 17 arranged on both sides of the frame or framework extend in the longitudinal direction X of the harvester. Where appropriate, the distance of the booms 17 and the working units 18 engaging on the booms 17 from the ground can be increased in advance via the articulated cylinder 18. After the booms 17 of the harvester 10 have been transferred into a position in which the booms 17 extend in the longitudinal direction of the harvester 10, then exclusively the pivoting cylinders 23 are used for the further transfer movement in order to move the booms 17 into the receptacles 27 arranged on both sides of the frame or framework 11. Where appropriate, the articulated cylinder 28 can be controlled simultaneously or slightly staggered in time.

When transferring the harvester 10 starting from the transport position into the working position, first of all exclusively the pivoting cylinders 23 are used for the respective transfer movement in order to move the booms 17 out of the receptacles 27 arranged on both sides of the frame or framework 11, wherein here first of all the orientation of the booms 17, which extend in the longitudinal direction, remains unchanged. Subsequently, the pivoting cylinders 23 and lifting cylinders 24 arranged on both sides of the frame or framework 11 are simultaneously hydraulically controlled and used for the respective transfer movement in order to pivot the booms 17 simultaneously about the folding axes 25, 26, to be precise until, on both sides of the frame or framework 11, the booms 17 with the working units 18 engaging thereon extend in the transverse direction of the harvester 10. The articulated cylinder 28 can also be controlled simultaneously here. When the booms 17 with the working units 18 extend in the transverse direction of the harvester, the working units 18 are subsequently lowered via the articulated cylinder 28 in order to adjust their distance from the ground.

Alternatively or in addition to the control of the pivoting cylinders 23 and lifting cylinders 24 by a control unit, at least one device consisting of purely hydraulic components, such as flow dividers, throttle valves, pressure compensators, etc. could also be provided in order to carry out a purely hydraulic flow distribution between the respective pivoting cylinder 23 and lifting cylinder 24, which device is designed to simultaneously control the pivoting cylinder 23 and lifting cylinder 24 arranged on the respective side of the frame or framework 11 in order to transfer the harvester 10 between the working position and the transport position at least over part of the transfer movement of the at least one boom 17 arranged on the respective side of the frame or framework 11 and to simultaneously use them for the respective transfer movement.

This device for hydraulic flow distribution could also be designed to simultaneously control the pivoting cylinders 23 and lifting cylinders 24 arranged on both sides of the frame or framework 11 in order to transfer the harvester 10 between the working position and the transport position at least over part of the transfer movement of the booms 17 arranged on both sides of the frame or framework 11 and to simultaneously use them for the respective transfer movement.

### LIST OF REFERENCE SIGNS

10 Harvester
11 Framework/frame
12 Longitudinal member
13 Drawbar
14 Coupling bracket
15 Chassis
16 Wheel
17 Boom
18 Working unit
19 Pickup
20 Belt conveyor segment
21 Covering
22 Roller hold-down device
23 Pivoting cylinder
24 Lifting cylinder
25 Folding axis
26 Folding axis
27 Receptacle
28 Articulated cylinder

1. An agricultural harvester (10),
having a frame or a framework (11) on which a chassis (15) engages,
having booms (17), wherein on both sides of the frame or framework (11) in each case at least one boom (17) engages on the frame or framework (11) in such a way that, in order to transfer the harvester (10) between a working position and a transport position, the respective boom (17) can be displaced relative to the frame or framework (11),
having working units (18), wherein in each case at least one working unit (18) engages on each of the booms (17) and can be displaced together with the respective boom (17),
having pivoting cylinders (23) and lifting cylinders (24), wherein on each side of the frame or framework (11) in each case a pivoting cylinder (23) and in each case a lifting cylinder (24) are arranged which displace the at least one boom (17) arranged on the respective side of the frame or framework (11), together with the at least one working unit (18), over a respective transfer movement between the working position and the transport position,
having a control unit and/or at least one device for hydraulic flow distribution which are designed to simultaneously control the pivoting cylinder (23) and lifting cylinder (24) arranged on the respective side of the frame or framework (11) in order to transfer the harvester (10) between the working position and the transport position at least over part of the transfer movement of the at least one boom (17) arranged on the respective side of the frame or framework (11) and to simultaneously use them for the respective transfer movement.

2. The agricultural harvester (10) according to claim 1, characterized in that the control unit and/or the at least one device for hydraulic flow distribution are designed to simultaneously control the pivoting cylinders (23) and lifting cylinders (24) arranged on both sides of the frame or framework (11) in order to transfer the harvester (10) between the working position and the transport position at least over part of the transfer movement of the booms (17) arranged on both sides of the frame or framework (11) and to simultaneously use them for the respective transfer movement.

3. The agricultural harvester (10) according to claim 1, characterized in that
the booms (17) arranged on both sides of the frame or framework (11) extend in the transverse direction of the harvester (10) in the working position of the harvester (10),
the booms (17) arranged on both sides of the frame or framework (11) extend in the longitudinal direction of the harvester (10) in the transport position of the harvester (10),
the control unit is designed to simultaneously hydraulically control the pivoting cylinders (23) and lifting cylinders (24) arranged on both sides of the frame or framework (11) in order to transfer the harvester (10) between the working position and the transport position at least over that part of the transfer movement in which the booms (17) are transferred between the extension thereof in the transverse direction of the harvester (10) and the extension thereof in the longitudinal direction of the harvester (10) and to simultaneously use them for the respective transfer movement.

4. The agricultural harvester (10) according to claim 1, characterized in that on both sides of the frame or framework (11) in each case at least one receptacle (27) engages on the frame or framework (11) and is designed for form-fittingly arranging a boom (17) arranged on the respective side of the frame or framework (11) in the transport position of the harvester (10).

5. The agricultural harvester (10) according to claim 4, characterized in that the control unit is designed, when the booms (17) arranged on both sides of the frame or framework (11) extend in the longitudinal direction of the harvester, to hydraulically control exclusively the respective pivoting cylinder (23) and use it for the corresponding part of the respective transfer movement in order, during the transfer of the harvester (10) from the working position into the transport position, to move the respective boom (17) into the respective receptacle (27) and, during the transfer of the harvester (10) from the transport position into the working position, to move the respective boom (17) out of the respective receptacles (27).

6. The agricultural harvester (10) according to claim 1, characterized in that the respective pivoting cylinder (23) articulatedly engages on one side on the frame or framework (11) and on the other side on the respective boom (17), wherein, in the working position of the harvester (10), a folding axis (25) extends in the vertical direction between the respective pivoting cylinder (23) and the respective boom (17).

7. The agricultural harvester (10) according to claim 1, characterized in that the respective lifting cylinder (24) articulatedly engages on one side on the frame or framework (11) and on the other side on the respective boom (17), wherein, in the working position of the harvester (10), a folding axis (26) extends in the horizontal direction between the respective lifting cylinder (24) and the respective boom (17).

8. The agricultural harvester (10) according to claim 1, characterized in that the frame or the framework (11) has a first section (11b) on which the chassis (15) engages, and a second section (11a) on which a drawbar (13) engages, wherein these two sections (11a, 11b) can be displaced relative to each other by means of an articulated cylinder (28) about an axis extending in the transverse direction of the harvester in order to change the distance of the working units (18) from the ground.

9. The agricultural harvester (10) according to claim 8, characterized in that the control unit is designed to hydraulically control the articulated cylinder (28) at least over part of the transfer movement of the respective boom simultaneously with the pivoting cylinder (23) and lifting cylinder (24) and to simultaneously use them for the respective transfer movement.

10. The agricultural harvester (10) according to claim 1, characterized in that the harvester is a forage harvester.

11. The agricultural harvester (10) according to claim 10, characterized in that the forage harvester is a merger or pickup belt rake, wherein a pickup (19) and a belt conveyor segment (20) engage, as working unit (18), on each of the booms (17).

12. A method for operating an agricultural harvester (10) according to claim 1, wherein the pivoting cylinder (23) and lifting cylinder (24) arranged on the respective side of the frame or framework (11) are simultaneously hydraulically controlled in order to transfer the harvester (10) between the working position and the transport position at least over part of the transfer movement of the at least one boom (17) arranged on the respective side of the frame or framework (11) and simultaneously used for the respective transfer movement.

13. The method according to claim 12, characterized in that, during the transfer of the harvester (10) from the working position into the transport position, firstly the pivoting cylinder (23) and lifting cylinder (24) arranged on both sides of the frame or framework (11) are simultaneously hydraulically controlled and used for the respective transfer movement until the booms (17) arranged on both sides of the frame or framework (11) extend in the longitudinal direction of the harvester (10), wherein subsequently exclusively the pivoting cylinders (23) are used for the respective transfer movement in order to move the booms (17) into the receptacles (27) arranged on both sides of the frame or framework (11).

14. The method according to claim 12, characterized in that, during the transfer of the harvester (10) from the transport position into the working position, firstly exclusively the pivoting cylinders (23) are used for the respective transfer movement in order to move the booms (17) out of the receptacles (27) arranged on both sides of the frame or framework (11), wherein subsequently the pivoting cylinders (23) and lifting cylinders (24) arranged on both sides of the frame or framework (11) are simultaneously hydraulically controlled and used for the respective transfer movement until the booms arranged on both sides of the frame or framework (11) extend in the transverse direction of the harvester (10).
